(19) United States
(12) Patent Application Publication
(10) Pub. No.: US 2021/0115996 A1
(43) Pub. Date: Apr. 22, 2021

(54) ADJUSTABLE VIBRATION DAMPER WITH A DAMPING VALVE DEVICE

(71) Applicant: ZF FRIEDRICHSHAFEN AG, Friedrichshafen (DE)

(72) Inventors: Lukas RUHMANN, Memmelsdorf (DE); Thomas MANGER, Wasserlosen (DE); Thomas SOLF, Sulzheim (DE); Bernd ZEISSNER, Volkach (DE); Manuel GUMPERT, Hofheim (DE)

(21) Appl. No.: 17/072,184

(22) Filed: Oct. 16, 2020

(30) Foreign Application Priority Data
Oct. 17, 2019 (DE) 10 2019 215 984.2

(51) Int. Cl. F16F 9/46; F16F 9/16

(52) U.S. Cl. CPC F16F 9/466; F16F 9/16

(57) ABSTRACT

A vibration damper comprises at least one adjustable damping valve device for each working direction of the vibration damper. A fluid connection between a compensation space and a work chamber is controlled by a check valve that is hydraulically connected in parallel with the adjustable damping valve device. A constant bypass is connected in parallel with the check valve and the damping valve device.

### BACKGROUND OF THE INVENTION

### 1. Field of the Invention

The invention is directed to an adjustable vibration damper with a damping valve device.

### 2. Description of Related Art

DE 10 2017 209 609 A1 describes a vibration damper with an adjustable damping valve device for each working direction of the vibration damper. FIG. 1 shows an equivalent hydraulic circuit diagram of DE 10 2017 209 609 A1. According to this diagram, a check valve is hydraulically connected in parallel with the adjustable damping valve device for damping the extension direction of a piston rod. This enables a restriction-free return flow of damping medium from a compensation space into a work chamber on the piston rod side when the piston rod executes a retraction movement.

A damping valve at a piston is known from DE 40 25 115 C2, wherein the damping valve is constructed as a restrictor check valve. When flow impinges on a valve disk proceeding from restriction bores, a check valve opens and releases a permanently open pilot orifice section. When a pressure force in an annular chamber below the valve disk exceeds a defined level, the at least one valve disk lifts from a valve seat of an axial support so that an outflow cross section, which is larger than the pilot orifice section is available. The restrictor check valve is formed by the permanently open pilot orifice section in combination with at least one liftable valve disk.

The advantageous functioning of the direction-dependent pilot orifice section at a piston would also be possible, in principle, in a vibration damper with the damping valve device according to DE 10 2017 209 609 A1. On the other hand, a vibration damper according to DE 10 2017 209 609 A1 can also be operated without being outfitted with a valve disk with a closed piston, and the damping force is then generated only in the damping valve devices.

### SUMMARY OF THE INVENTION

It is an object of one aspect of the present invention to outfit a vibration damper with a direction-dependent pilot orifice section to be implemented external to a piston.

One aspect of the invention is a constant bypass is connected in parallel with the check valve and the damping valve device.

For the vibration damper, the constant bypass forms a pilot orifice section that influences a first segment of a damping force characteristic. The larger the pilot orifice section, the lower the damping force of the vibration damper starting from a standstill. The advantage consists in that it is possible to use a simple displacer as piston for the vibration damper without additional damping valves.

In a further advantageous aspect of the invention, the bypass and the check valve are a component part of an additional restrictor check valve. The restrictor check valve presents a compact damping valve unit which works without elaborate channels.

With a view to wide versatility and, therefore, adaptability of the damping force characteristic to a target characteristic, the bypass and a further check valve are combined to form a second restrictor check valve. By combining two restrictor check valves, a large variety of damping force characteristics can be configured in a direction-dependent manner.

To this end, it can be provided that the bypass cross section of the first restrictor check valve has different dimensions than the bypass cross section of the second restrictor check valve.

Further, the check valves of the two restrictor check valves can have a different opening force for adapting the damping force characteristic.

The two restrictor check valves are arranged hydraulically in series for purposes of a simple design and guidance of the flow channels.

Additionally, the valves can be arranged in such a way that a closing spring of the first restrictor check valve and a closing spring of the second restrictor check valve are mechanically connected in series. This likewise simplifies the construction of the utilized valves.

A further embodiment form is characterized in that at least one of the restrictor check valves is coupled with a check valve which is additional to the other restrictor check valve. Accordingly, a multi-stepped pilot orifice section can be used, e.g., for a throughflow direction, whereas a blocking of the pilot orifice sections can be provided in the opposite incident flow direction of the valves.

It has proven particularly advantageous with respect to design layout when the restrictor check valve is constructed as a movable valve body which is preloaded on a valve seat surface by a closing spring and which has at least one through-opening as bypass.

### BRIEF DESCRIPTION OF THE DRAWINGS

The invention will be described in more detail referring to the following description of the figures. The drawings show:

FIG. 1 is an equivalent diagram for a vibration damper according to the prior art;

FIG. 2 is a vibration damper construction;

FIG. 3A is a section from FIG. 2;

FIG. 3B is an equivalent diagram of the section from FIG. 3A;

FIGS. 4A and 4B is a variant based on FIG. 3 with additional check valve;

FIGS. 5A and 5B is a variant of FIG. 4A, 4B; and

FIGS. 6A and 6B is a variant with three restrictor check valves based on FIGS. 5A, 5B.

### DETAILED DESCRIPTION OF THE PRESENTLY PREFERRED EMBODIMENTS

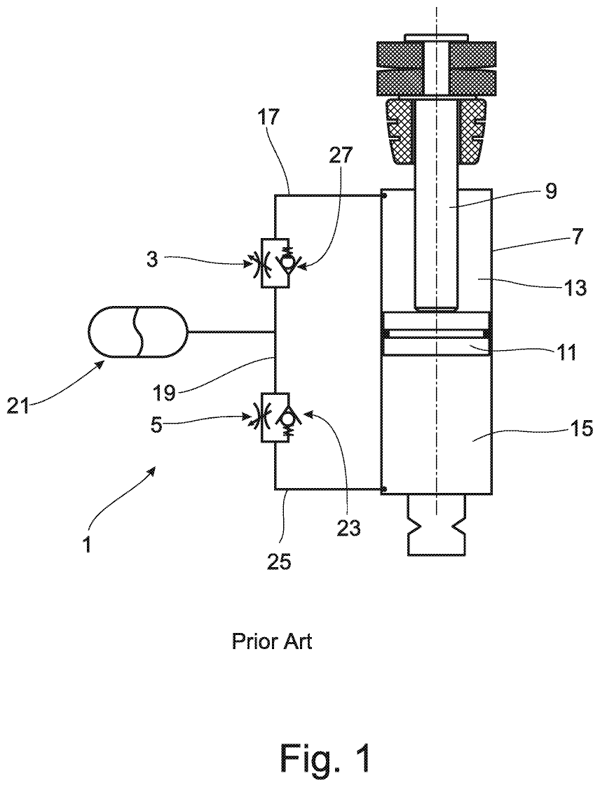

FIG. 1 shows an equivalent diagram for the adjustable vibration damper 1 known from DE 10 2017 209 609 A1 with a respective adjustable damping valve device 3, 5 for each working direction of the vibration damper 1. The vibration damper 1 comprises a cylinder 7 that is completely filled with damping medium and in which a piston rod 9 with a piston 11 is axially movably guided. The piston 11 divides the cylinder 7 into a work chamber 13 on the piston rod side and a work chamber 15 remote of the piston rod. During an extension movement of the piston rod 9 out of the cylinder 7, the damping medium located in the work chamber 13 on the piston rod side is displaced via a fluid line 17 to the adjustable damping valve device 3. Depending on the degree of opening of the adjustable damping valve device 3, a greater or lesser damping force results depending on the piston rod extension velocity. The displaced damping medium can flow via an intermediate line 19 into a compensation space 21 or via a check valve 23 and a second fluid line 25 into the work chamber 15 remote of the piston rod.

During a retraction movement of the piston rod 9, the damping medium is supplied to the second adjustable damping valve device 5 from the work chamber 15 remote of the piston rod via the second fluid line 25 for damping the retraction movement. The check valve 23, which is hydraulically connected in parallel, is closed. Damping medium can likewise flow into the compensation space 21 via the intermediate line 19 or into the piston rod-side work chamber 13 via the second check valve 27 and the first fluid line 17.

This basic flow path of the damping medium depending on the movement direction of the piston rod 9 is also provided in the following configurations of the invention.

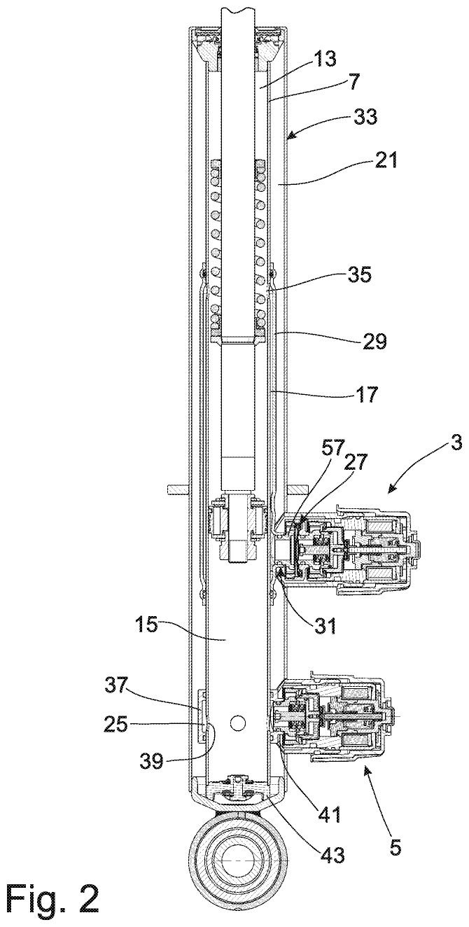

FIG. 2 shows a constructional implementation of the vibration damper 1 according to the equivalent diagram in FIG. 1. A portion of the cylinder 7 is covered by a first intermediate tube 29 which, together with the cylinder 7, forms an annular space functioning as first fluid line 17. The intermediate tube 29 has a connection piece 31 which forms a connection to the first damping valve device 3. The first damping valve device 3 is secured to an outer lateral surface of a receptacle tube 33 covering the cylinder 7. With the cylinder 7, the receptacle tube 33 forms an annular space which serves as compensation space 21 and to which the first damping valve device 3 is also connected on the outlet side. The check valve 27 is arranged hydraulically parallel to the damping valve device 3. The transition from the piston rod-side work chamber 13 into the fluid line 17 is effected via a first connection orifice 35 in the cylinder 7.

A second intermediate tube 37, which forms the second fluid line 25 with cylinder 7, is arranged in a sealed manner on the cylinder 7 at an axial distance from the first intermediate tube 29. In the overlapping area of the second intermediate tube 37, the cylinder 7 has a second connection orifice 39 that connects the work chamber 15 remote of the piston rod to the second fluid line 25 formed by the annular space between the cylinder 7 and the second intermediate tube 27. The second intermediate tube 37 is also formed via a connection piece 41 with the second damping valve device 5, which is likewise secured to the receptacle tube 33. Identical to the first damping valve device 3, the second damping valve device 5 is also connected to the compensation space 21 on the outlet side.

On the bottom side, the cylinder 7 has a bottom valve body 43 with the check valve 23 that opens into the work chamber remote of the piston rod proceeding from the compensation space 21 in flow direction.

In this construction of the vibration damper 1, the compensation space 21 and the intermediate line 19 occupy the same physical space.

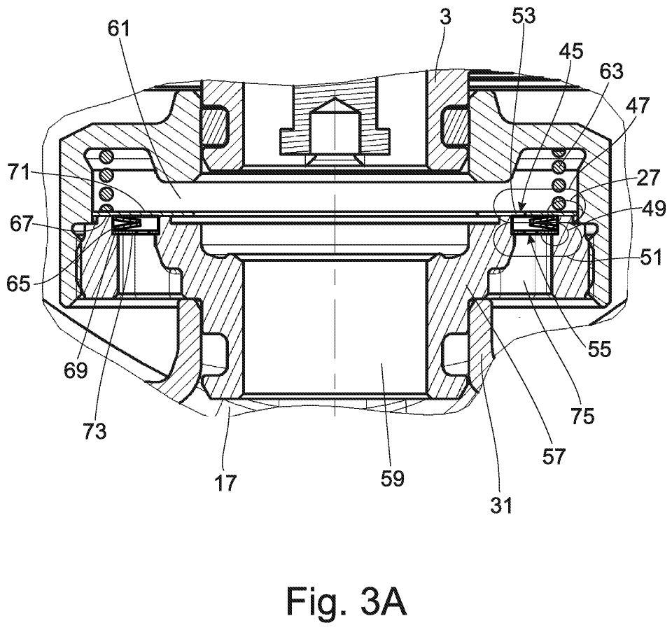

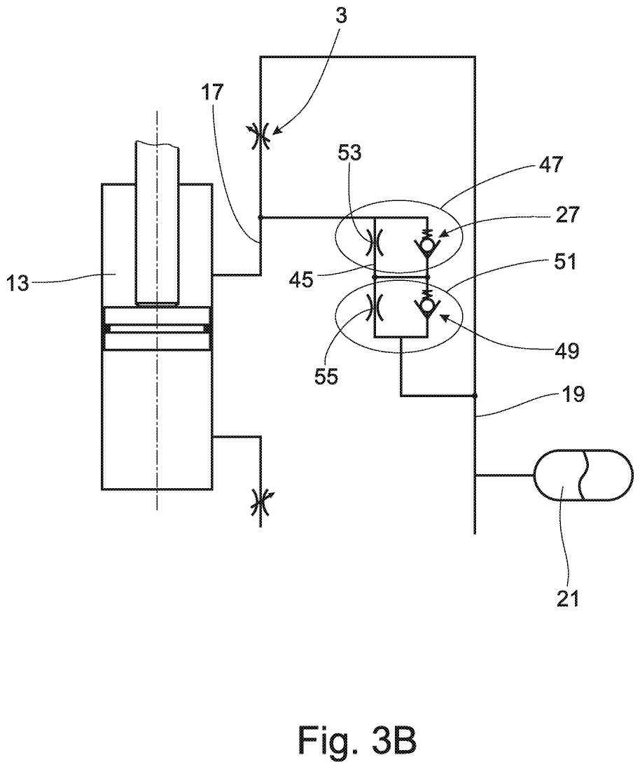

A difference between the invention and the prior art according to FIG. 1 will be appreciated from FIGS. 3A and 3B viewed in conjunction. While the prior art has only one check valve 27 in parallel with the adjustable damping valve device 3, a constant bypass 45 is connected in parallel with check valve 27 and damping valve device 3 in FIGS. 3A and 3B. This constant bypass 45 is provided for both flow directions of the damping medium. Accordingly, the damping force level of the vibration damper 1 can be reduced if necessary compared with a vibration damper 1 without a bypass so that a gain in comfort is achieved.

As is readily discernible particularly from the equivalent diagram in FIG. 3B, the bypass 45 is bifurcated and, with the check valve 27, forms a component part of a restrictor check valve 47. The bypass 45 and an additional check valve 49 are combined to form a second restrictor check valve 51. Accordingly, there are two restrictor check valves 47; 51 which are arranged hydraulically in series. The two restrictor check valves have different characteristics.

On the one hand, a first bypass cross section 53, as part of the bypass 45 of the first restrictor check valve 47, is dimensioned differently than the second bypass cross section 55 of the second restrictor check valve 51.

Additionally, the check valves 27; 49 of the two restrictor check valves 47; 51 have a different opening force. Therefore, there are at least four parameters available for adapting the damping force characteristic of the vibration damper 1 for a movement direction.

In FIG. 3A, the details of construction are realized by way of example. FIG. 3A shows a partial section of the adjustable damping valve device 3 in the area of the first fluid line 17 and the area of connection to the adjustable damping valve device 3. A central through-opening 59 which connects an annular space 61 to the fluid line 17 in flow direction proceeding from the piston rod-side work chamber 13 is formed in a connection ring 57. Reference is made, for example, to DE 10 2010 062 264 A1 with regard to the construction of the adjustable damping valve device. The two restrictor check valves 47; 51 are connected to the annular space 61. The two restrictor check valves 47; 51 have in common that they are formed as a movable valve body 71; 73 which is preloaded on a valve seat surface 67; 69 by a closing spring 63; 65 and has at least one through-opening as bypass cross section 53; 55. It will be appreciated from the graphic depiction of the individual through-openings by itself that the dimensions thereof differ from one another. This is also true of the closing springs 63; 65. For purposes of a compact construction, the closing spring 63 of the first restrictor check valve 47 and the closing spring 65 of the second restrictor check valve 51 are mechanically connected in series in that the closing spring 65 is axially supported at the valve body 71.

When a flow impinges on the restrictor check valves 47, 51 via the through-opening 59 in the connection ring 57, i.e., proceeding from the piston rod-side work chamber 13, the damping medium enters the annular space 61. The amount of damping medium flowing through the series-arranged restrictions or bypass cross sections 53 varies depending on the setting of the adjustable damping valve device 3, and the damping force is determined by the smaller of the two bypass cross sections. In this embodiment example, the smaller bypass cross section 55 is implemented in the valve disk 73. The two valve bodies 71; 73 are held on their valve seat surfaces 67; 69 by the two closing springs 63; 65 so that the check valves 27; 49 are closed.

During a retraction movement of the piston rod 9 into the cylinder 7, the volume of the piston rod-side work chamber 13 increases. As a result, damping medium is supplied from the work chamber 15 remote of the piston rod and compensation space 21 via the intermediate line. For this purpose, through-channels 75 are formed in the connection ring, and these through-channels 75 can connect the intermediate line 17 and compensation space 21 to the annular space 61. When a flow impinges on the restrictor check valve 51, the small bypass cross section 55 initially determines the damping force. The second, larger bypass cross section 45 in the valve body has no effect. With increasing incident flow pressure on the restrictor check valve 51, the valve body 73 lifts from its valve seat surface 69 against the force of the closing spring 65. The flow cross section now available for the damping medium is appreciably larger than the bypass cross section 45 in the still-closed valve body 71 of the restrictor check valve 47. Therefore, this cross section determines the damping force of the vibration damper. Should the pressure level suffice, this valve body 71 can also lift from its valve seat surface 67 against the force of closing spring 63 so that both check valves 27; 49 are open and the maximum flow cross section for the damping medium is available for flowing into the piston rod-side work chamber 13.

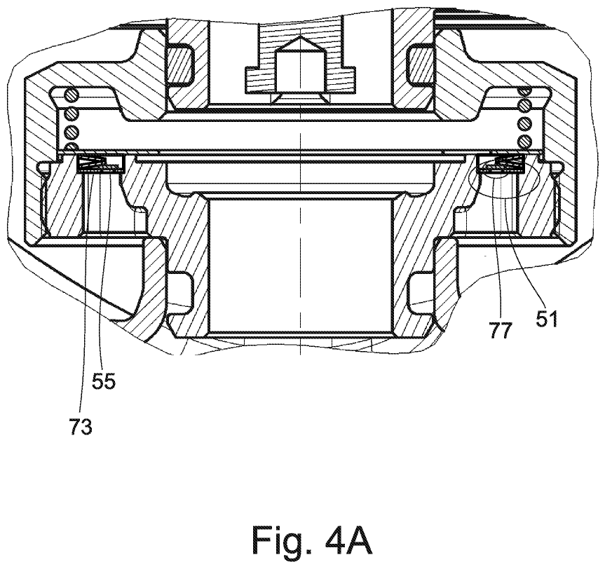

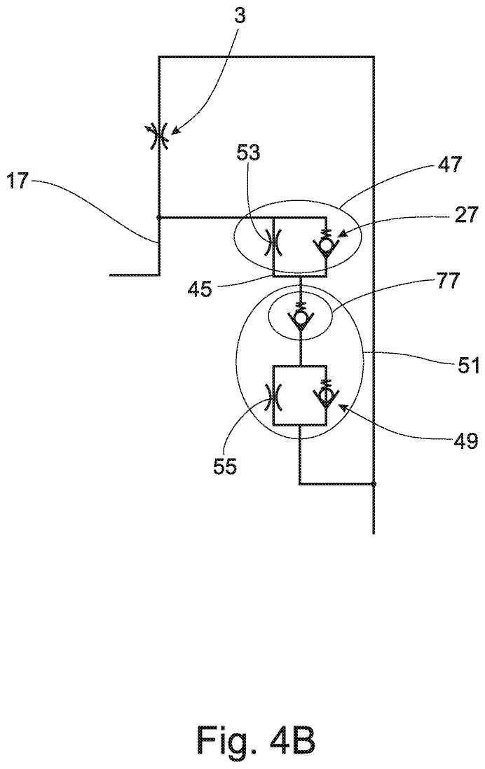

The arrangement according to FIGS. 4A and 4B is based on the arrangement according to FIG. 3A. Additionally, at least one of the restrictor check valves 51 is coupled with a check valve 77 that is additional to the other restrictor check valve 47. The additional check valve 77 in the valve body 73 is functionally associated with the smaller bypass cross section 55 of bypass 45 and is formed as a simple flutter plate. With a flow impinging on the two restrictor check valves proceeding from the piston rod-side work chamber 13, the additional check valve 77 blocks this flow path. The displaced damping medium in its entirety must flow through the adjustable damping device. In the opposite flow direction, i.e., proceeding from the intermediate line 17 and compensation space, the additional check valve 77 opens even with a very small incident flow. Qualitatively speaking, the damping force characteristic is exactly the same as that described referring to FIGS. 3A and 3B.

It will be apparent from Figure pair 5A; 5B that the additional check valve 77 can also cooperate with the valve body 71 of the restrictor check valve 47. Accordingly, the additional check valve 77 is also located spatially upstream of the two restrictor check valves proceeding from the annular space 61. The additional check valve has a simple annular disk 79 which is likewise formed as a reed valve in combination with an outer centering disk 81, a cover disk 83 and an intermediate gap 85. Operation is identical to that described referring to FIGS. 4A; 4B.

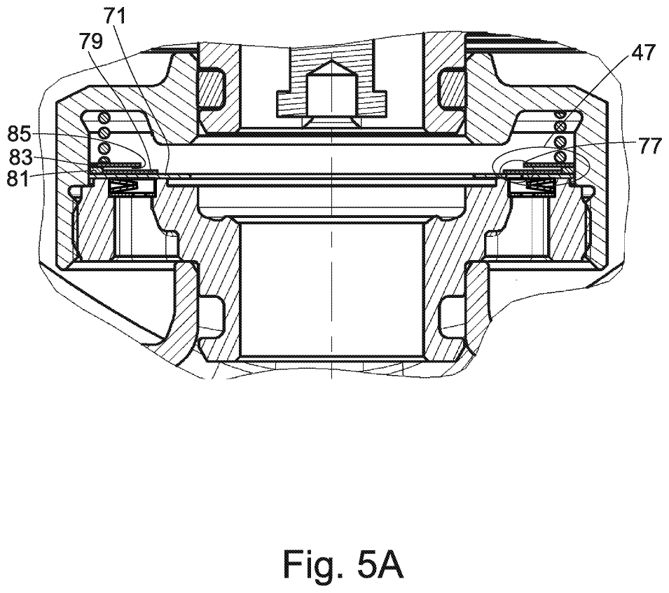

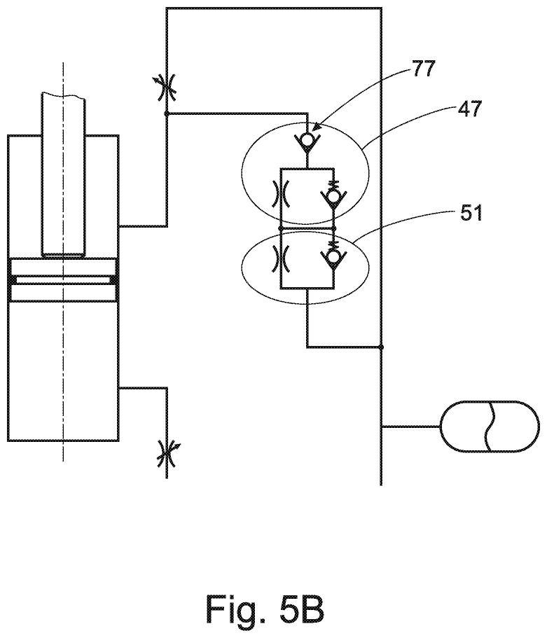

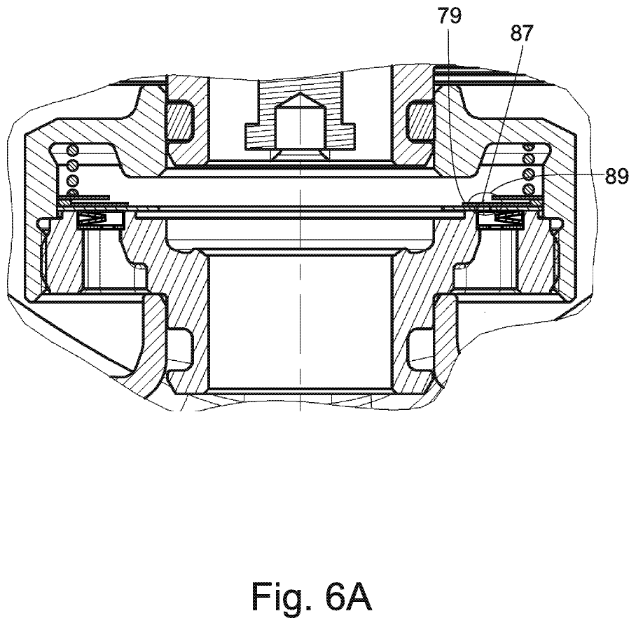

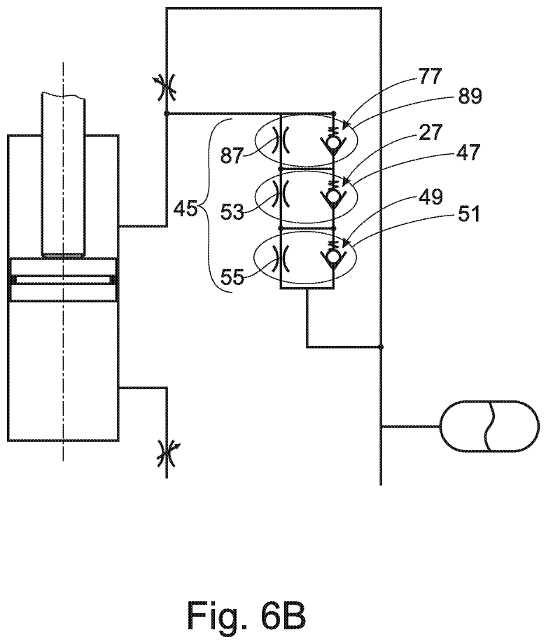

The construction according to FIGS. 6A; 6B is again based on the construction according to FIG. 5A; 5B. In contrast, the additional check valve according to FIG. 6A is formed with a bypass cross section 87 that is smaller than the cross sections of the bypasses 53; 55 of the two restrictor check valves 47; 51. Accordingly, a total of three restrictor check valves 47; 51; 89 are arranged functionally in series as is shown in FIG. 6B. In contrast to the first check valve 27 and second check valve 49, the third check valve 77 is formed without a closing spring, again as a reed valve.

When a flow impinges on the series arrangement proceeding from the piston rod-side work chamber 13 and the annular space 61, the annular disk 79 of the third restrictor check valve 89 occupies a closed position so that only the third bypass cross section 87 is open. Consequently, this cross section also determines the achievable damping force within the arrangement of restrictor check valves in this incident flow direction. During an incident flow proceeding from the intermediate line 17 and compensation space 21, the third restrictor check valve 89 has no effect because it opens even with minimal incident flow. Therefore, the same damping force behavior exists for this incident flow direction as that described referring to FIGS. 5A; 5B.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A vibration damper comprising:
at least one adjustable damping valve device for each working direction of the vibration damper;
a check valve hydraulically connected in parallel with the at least one adjustable damping valve device and configured to control a fluid connection between a compensation space and a work chamber; and
a constant bypass connected in parallel with the check valve and the at least one adjustable damping valve device,
wherein a first restrictor check valve comprises at least the check valve.

2. The vibration damper according to claim 1, wherein the constant bypass and the check valve are a component part of a second restrictor check valve.

3. The vibration damper according to claim 2, wherein the second restrictor check valve formed by:
a further check valve; and
the constant bypass.

4. The vibration damper according to claim 2, wherein a bypass cross section of a first restrictor check valve has different dimensions than a bypass cross section of the second restrictor check valve.

5. The vibration damper according to claim 2, wherein respective check valves of the first restrictor check valve and the second restrictor check valve have different opening forces.

6. The vibration damper according to claim 2, wherein the first restrictor check valve and the second restrictor check valve are arranged hydraulically in series.

7. The vibration damper according to claim 2, further comprising:
a first closing spring of the first restrictor check valve; and
a second closing spring of the second restrictor check valve,
wherein the first closing spring and the second closing spring are mechanically connected in series.

8. The vibration damper according to claim 2, further comprising
an additional check valve coupled to at least one of the first restrictor check valve and the second restrictor check valve.

9. The vibration damper according to claim 1, wherein the first restrictor check valve is a movable valve body which is preloaded on a valve seat surface by a closing spring and which has at least one through-opening configured as a bypass cross section.
